(19) United States
(12) Patent Application Publication
(10) Pub. No.: US 2014/0033048 A1
(43) Pub. Date: Jan. 30, 2014

(54) SYSTEM FOR CREATING INTERACTIVE ELECTRONIC DOCUMENTS AND CONTROL METHOD THEREOF

(71) Applicant: MOGLUE INC., Seoul (KR)

(72) Inventors: Tae Woo KIM, Seoul (KR); Nam Su KIM, Seoul (KR)

(73) Assignee: MOGLUE INC., Seoul (KR)

(21) Appl. No.: 13/950,796

(22) Filed: Jul. 25, 2013

(30) Foreign Application Priority Data
Jul. 25, 2012 (KR) 10-2012-0081395

(51) Int. Cl. G06F 3/0484

(52) U.S. Cl. CPC G06F 3/0484
USPC 715/731

(57) ABSTRACT

Provided are a system for creating interactive electronic documents and a control method thereof. Recording information such as texts and images may be recorded in an electronic medium to make it easy and convenient to create electronic documents available like books. A preview may be performed quickly and easily during an electronic document creating operation.

### CROSS-REFERENCE TO RELATED PATENT APPLICATION

This application claims the benefit of Korean Patent Application No. 10-2012-0081395, filed on Jul. 25, 2012, in the Korean Intellectual Property Office, the disclosure of which is incorporated herein in its entirety by reference.

### BACKGROUND OF THE INVENTION

1. Field of the Invention

The present invention relates to a system for creating interactive electronic documents, which is capable of recording information such as texts and images in an electronic medium to make it easy and convenient to create electronic documents available like books, and is capable of quickly and easily performing a preview during an electronic document creating operation, and a control method thereof.

2. Description of the Related Art

Electronic book or e-book refers to a digital document that is available like a book by recording information such as texts or images in an electronic medium. That is, electronic book or e-book collectively refers to a digital document in which content of publications published or publishable as a document is recorded in a digital data form in an electronic recording medium or a storage device, and the content is readable and viewable using a computer or a mobile phone through a wired/wireless information communication network.

E-book industry has rapidly developed since Japanese Nippon Electric Company (NEC) first commercialized e-book. E-book has an enhanced screen resolution and various edit functions. A page may be turned on by click alone. In addition, a scale of a text, a document search or content download from an Internet book store or library, and the like are enabled. Furthermore, e-book is much cheaper than a paper book, time may be saved through on-line shopping, and only a necessary part of an e-book may be separately purchased. While reading a book, a user may view a video material or listen to a background music. A user may also store e-books in a PDA or a mobile terminal and search a desired book with ease at any place. In view of publishing companies, book production costs and distribution costs such as printing or bookbinding are reduced, charge of stock is reduced, and it is easy to update content of books. Readers may save time because they can purchase e-books at a lower price than paper books through on-line shopping, instead of going to a book store. In addition, while reading a book, the readers may view a video material or listen to a background music. The readers may also store e-books in a PDA or a mobile terminal and search a desired book with ease at any place.

The background art described above is technology information that has been held by the inventors so as to derive the present invention or has been acquired during the deriving procedure. The background art is not considered as a known technology open to the public prior to the filing of this application.

### SUMMARY OF THE INVENTION

The present invention provides a system for creating interactive electronic documents, which is capable of recording information such as texts and images in an electronic medium to make it easy and convenient to create electronic documents available like books, and a control method thereof.

According to an aspect of the present invention, there is provided a control method of a system for creating interactive electronic documents, the control method including: adding one or more objects on a canvas displayed on the system by a received user input signal; assigning one or more action attributes and status attributes to the object by a received user input signal; assigning a predetermined trigger attribute to the action attribute assigned to the object by a received user input signal; and storing at least one of the object, the action attribute, the status attribute, and the trigger attribute.

The status attribute may be an execution order of the action attribute assigned to each of the objects.

A separate trigger attribute may be assigned to each of the action attributes.

When the object is added on the canvas, one or more action slots may be formed in one side of the added object.

When the action attribute and the status attribute are assigned to the object by the received user input signal, the action attribute displayed in one side of the canvas may be moved to the action slot by a drag and drop signal or a touch and drag signal received by a user interface unit.

When the action attribute is assigned to the object, one or more action slots may be further formed in one side of the assigned action attribute.

The one or more action slots may be arranged with respect to one of the objects in a first direction and a second direction different from the first direction, the first direction may represent a status attribute that is an action execution order, and the action attributes arranged on a same line in the second direction may represent the action attributes to be executed in a same status.

At least a part of the action attributes arranged in the same line in the second direction may have a same trigger attribute, the action attributes having the same trigger attribute may be simultaneously executed when the trigger is executed.

A status attribute to be subsequently executed may be set to each of the action attributes.

One side of a plurality of objects displayed on the canvas may be set as a target object, the other side thereof may be set as a trigger object, and the action of the target object may be executed when the action of the trigger object is operated.

According to another aspect of the present invention, there is provided a system for creating interactive electronic documents, the system including: an object control unit that generates, changes, and deletes one or more objects on a canvas displayed on the system by a received user input signal; an action attribute and status attribute control unit that assigns, changes, and deletes one or more action attributes and status attributes to the object by a received user input signal; a trigger attribute control unit that assigns, changes, and deletes a predetermined trigger attribute to the action attribute assigned to the object by a received user input signal; and a control unit that controls the object control unit, the action attribute and status attribute control unit, and the trigger attribute control unit, and stores at least one of the object, the action attribute, the status attribute, and the trigger attribute in a database.

According to another aspect of the present invention, there are provided other methods and systems for implementing the present invention, and a computer-readable medium storing a computer program for performing the methods.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic block diagram of a system for creating interactive electronic documents according to an embodiment of the present invention;

FIG. 2 is a detailed block diagram of the system illustrated in FIG. 1;

FIG. 3 is a flowchart illustrating an electronic document creating operation in a control method of a system for creating interactive electronic documents according to an embodiment of the present invention; and

FIGS. 4 to 9 illustrate execution screens of an electronic document creation application for performing the electronic document creating operation of FIG. 3.

### DETAILED DESCRIPTION OF THE INVENTION

Reference will now be made in detail to embodiments, examples of which are illustrated in the accompanying drawings. These embodiments will be described below so that those of ordinary skill in the art may easily work the embodiments. It should be understood that various embodiments of the present invention are different but not necessarily exclusive. For example, specific shapes, structures, and characteristics described herein may be modified from an embodiment to another, without departing from the scope of the present invention. In addition, it should be understood that positions or arrangements of individual components within each embodiment may be modified without departing from the spirit and scope of the present invention. Therefore, the following detailed description should not be construed as limiting the scope of the present invention. The scope of the present invention is to be determined only by the appended claims and their equivalents. Throughout the drawings, like reference numerals refer to like elements.

As used herein, the term “and/or” includes any and all combinations of one or more of the associated listed items. Expressions such as “at least one of,” when preceding a list of elements, modify the entire list of elements and do not modify the individual elements of the list.

Embodiments of the present invention will be described below in detail with reference to the accompanying drawings, so that those of ordinary skill in the art may easily work the embodiments.

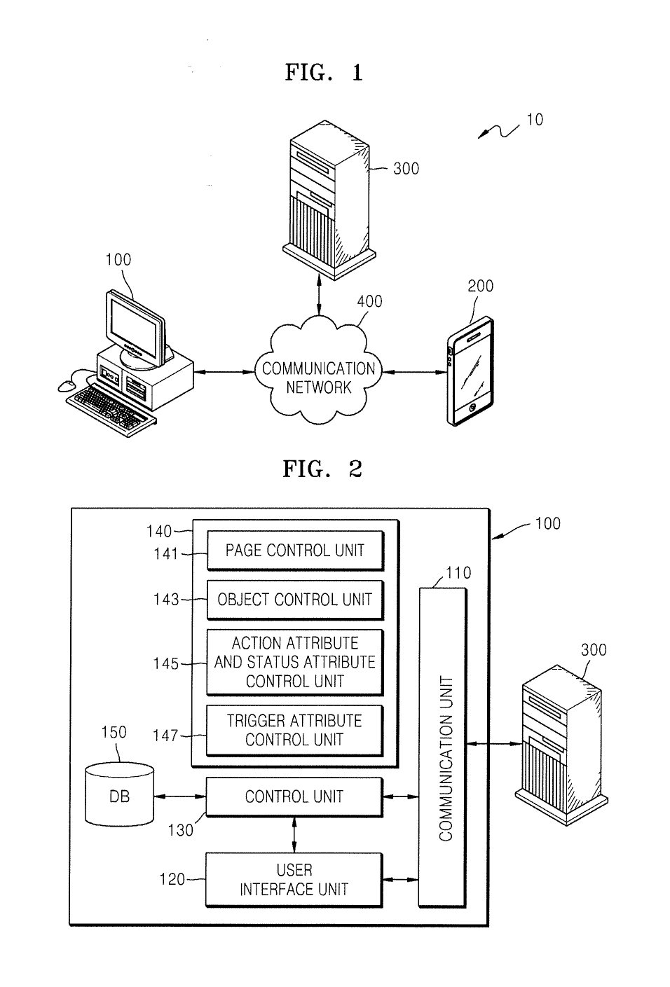

FIG. 1 is a schematic block diagram of a system 10 for creating interactive electronic documents according to an embodiment of the present invention.

Referring to FIG. 1, the system 10 for creating interactive electronic documents according to an embodiment of the present invention includes at least one electronic document creator 100, at least one electronic document reader 200, an application server 300 connected to the electronic document creator 100 and the electronic document reader 200, and a communication network 400 configured to connect the electronic document creator 100, the electronic document reader 200, and the application server 300.

The electronic document creator 100 and the electronic document reader 200 refer to various types of terminals on which applications capable of creating and reading electronic documents may be installed and driven. That is, the electronic document creator 100 and the electronic document reader 200 may be tablet personal computers, mobile phones, smartphones, telephones, personal computers, and components substantially identical to client computing environments such as personal digital assistants and e-book readers.

Although a personal computer as the electronic document creator 100 and a smartphone as the electronic document reader 200 are illustrated in FIG. 1, the spirit of the present invention is not limited thereto. As described above, any type of electronic devices may be considered as long as applications capable of creating and reading electronic documents may be installed and driven thereon

On the other hand, the communication network 400 function to connect the plurality of electronic document creators 100 and the application server 300 and/or connect the plurality of electronic document readers 200 and the application server 300. That is, the communication network 400 refers to a communication network that provides a connection path through which packet data may be transmitted and received after the electronic document creators 100 and the electronic document readers 200 are connected to the application server 300. The communication network 400 of FIG. 1 may be at least one of a fixed or wireless LAN, a WAN, an intranet, an extranet, a peer-to-peer network, a virtual private network, Internet or other communication network, or may be a component substantially identical to a communication network including a combination thereof.

The application server 300 are connected to the electronic document creator 100 and the electronic document reader 200 through the communication network 400. The application server 300 provides an electronic document creation application to the electronic document creator 100, provides an electronic document reading application to the electronic document reader 200, receives and stores a user input log of an electronic document creating operation from the electronic document creator 100, and receives and stores a user input log of an electronic document reading operation from the electronic document reader 200.

According to the system for creating interactive electronic documents according to the embodiment of the present invention, a series of creating operations of adding a predetermined object on a canvas displayed thereon, assigning an action attribute and a status attribute to the object, and assigning a trigger attribute to the action attribute may be performed by a convenient and intuitive manipulation. Hence, the electronic document creating operation is performed quickly and easily. Hereinafter, the system according to the embodiment of the present invention will be described in more detail.

FIG. 2 is a detailed block diagram of the system illustrated in FIG. 1.

Referring to FIG. 2, the electronic document creator 100 according to the embodiment of the present invention may include a communication unit 110, a user interface unit 120, a control unit 130, an electronic document creation unit 140, and a database 150. The electronic document creation unit 140 may include a page control unit 141, an object control unit 143, an action attribute and status attribute control unit 145, and a trigger attribute control unit 147.

The communication unit 110 connects the electronic document creator 100 to the application server 300 through the communication network (400 in FIG. 1), and performs a data transmission/reception function between the electronic document creator 100 and the application server 300.

The user interface unit 120 receives an input signal from a user and outputs an output signal to the user. The user interface unit 120 may include a keyboard, a mouse, a monitor, and the like. In addition, the user interface unit 120 may be a touch screen of a tablet personal computer.

Under the control of the control unit 130, the page control unit 141 adds a new page to an electronic document being created. For example, the electronic document such as e-book may include a plurality of pages. In this case, the page control unit 141 may add a new page to the electronic document and enables the control unit 130 to manage the electronic document on a page basis. The page generated by the page control unit 141 may be stored in a page database (not illustrated) of the database 150. The page database may store a serial number of the generated page, a previous/next page from the generated page, object information included in the page, and action and status information allocated to the object included in the page.

Under the control of the control unit 130, the object control unit 143 generates, changes, and deletes adds a new page with respect to the electronic document being created. For example, the object may be a plurality of characters appearing in the e-book, or a plurality of backgrounds appearing in the e-book (for example, trees, rocks, animals, plants, or the like). The object added by the object control unit 143 may be an object stored in an object database of the database 150, or an object imported by the user. The object imported by the user may be an object included in a package such as a photoshop document (PSD).

Under the control of the control unit 130, the action attribute and status attribute control unit 145 assigns, changes, and deletes the action attribute and the status attribute with respect to the object of the electronic document being created.

The action attribute refers to a predetermined action performed by each object. Each action attribute is basically performed when satisfying a predetermined status attribute and a predetermined trigger attribute, but may be exceptionally performed without regard to the status attribute. This will be described below. Examples of the action attribute may include an jump action, a move action, a waddle action, a swing action, a float action, a flip action, a shear action, a blink action, a fade action, a scale action, a page-move action, and the like. When such an action attribute is applied to the object, the object within the electronic document performs a predetermined action.

The status attribute refers to an execution order of a plurality of action attributes assigned to each object. The status attribute may be expressed as a number or a character string. For example, the status attribute may be assigned to each action attribute as follows: an action attribute, whose status attribute is 1, is executed for the first time, an action attribute, whose status attribute is 2, is executed for the second time, and an action attribute, whose status attribute is 3, is executed for the third time. The above-described status attribute may be automatically assigned to each object according to a position (operation slot to be described below) to which the action attribute is assigned.

In other words, when one or more action attributes are assigned to the object, each action attribute is executed when a specific status attribute (one or more attributes may be combined) and a specific trigger attribute are satisfied. Alternatively, by setting an exceptional case, the action attribute may be executed when only a specific trigger attribute is satisfied, without regard to a status attribute value.

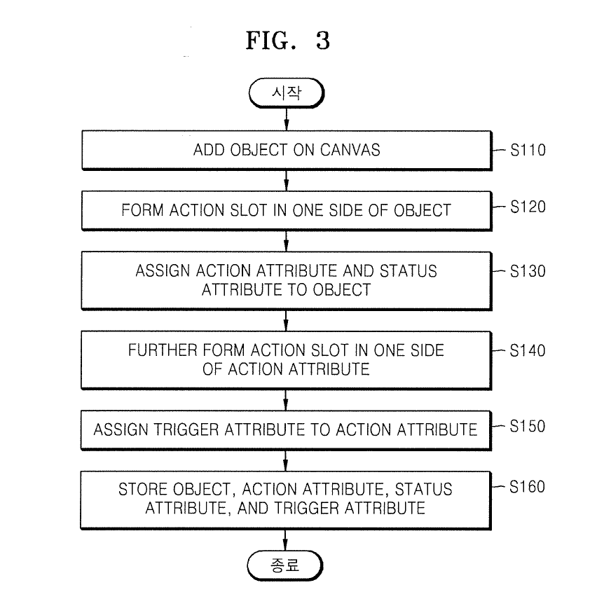

The status attribute may also be assigned to the page and the book, as well as the object. That is, in order to operate the action attribute assigned to the specific object, a specific action attribute may be operated when a trigger attribute is satisfied with reference to a status attribute of an arbitrary object, a page, or a whole book. This will be described below in detail with reference to FIG. 3.

The object added by the action attribute and status attribute control unit 145 may be an action attribute and a status attribute stored in the action attribute and status attribute database of the database 150, or an action attribute and a status attribute imported by the user.

Under the control of the control unit 130, the trigger attribute control unit 147 assigns, changes, and deletes the trigger attribute with respect to each action attribute of the electronic document being created.

The trigger attribute refers to an action execution condition for operation of each attribute. Examples of the trigger attribute may include a screen touch, a drag/move, a shake, a swipe at a reader, a page loading, and a status attribute change. If such a trigger attribute is assigned to the action attribute, a relevant action attribute is executed when an action execution condition satisfying the trigger attribute is executed. For example, in a case where a “screen touch” is set as a trigger attribute of a certain action attribute, the corresponding action attribute is executed when a screen is touched. In a case where a “page loading” is set as a trigger attribute of a certain action attribute, the corresponding action attribute is executed when a relevant page is loaded.

Although not illustrated, the electronic document creation unit 140 may further include a log storage unit. Under the control of the control unit 130, the log storage unit (not illustrated) stores an electronic document creation log in a log database (not illustrated). The electronic document creation log may be a record of various input signals input from the user during the electronic document creating operation. For example, the number of generated pages, a creation period of each page, the number of selections of each object, each action and status information, and an addition method of each object, each action and status information (for example, a double click, a drag and drop, or a touch and drag) may be stored as the electronic document creation log. Furthermore, under the control of the control unit 130, the electronic document creation log stored in the log database by the log storage unit may be transferred to the application server 300. The application server 300 may analyze the received log and analyzes predetermined statistics.

The database 150 may store the page database, the object database, the action attribute and status attribute database, and the log database. The page database may store a serial number of the generated page, a previous/next page from the generated page, object information included in the page, and action and status information allocated to the object included in the page. The object database may store characters appearing in the e-book or objects such as backgrounds. The action attribute and status attribute database may store action and status information allocated to the objects. The log database may store the electronic document creation log that is a record of various input signals input from the user during the electronic document creating operation. The electronic document creation log may include the number of generated pages, a creation period of each page, the number of selections of each object, each action and status information, and an addition method of each object, each action and status information.

The control unit 130 controls the addition of the object, the assignment of the action attribute and the status attribute, and the assignment of the trigger attribute on the electronic document.

According to the embodiment of the present invention, the preview may be quickly and easily performed during the electronic document creating operation.

Hereinafter, a control method of a system for creating interactive electronic documents according to an embodiment of the present invention will be described.

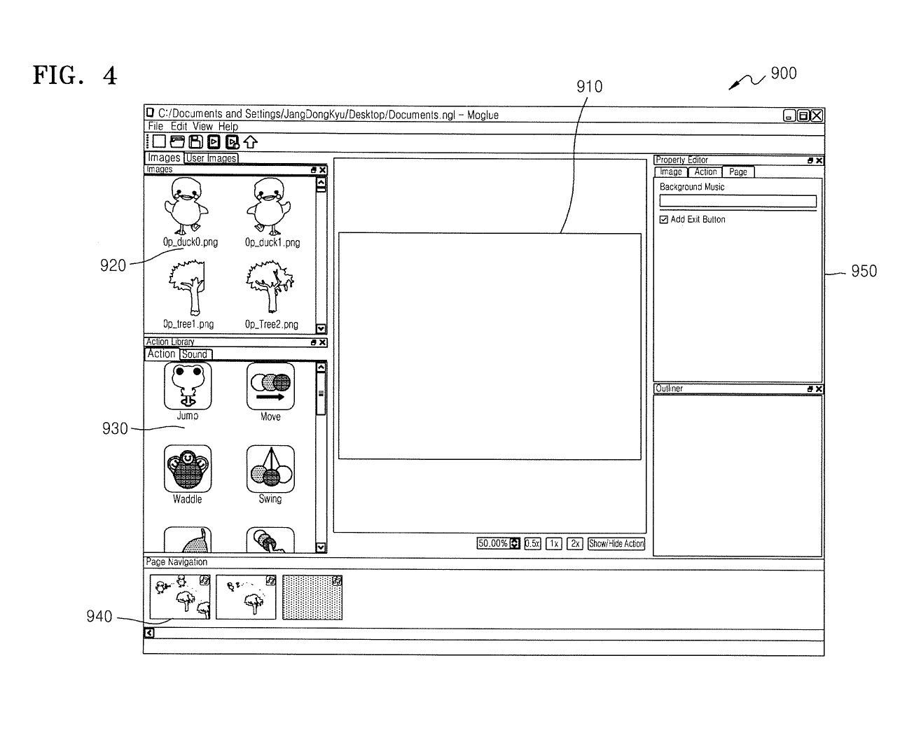

FIG. 3 is a flowchart illustrating an electronic document creating operation in a control method of a system for creating interactive electronic documents according to an embodiment of the present invention, and FIGS. 4 to 9 illustrate execution screens of an electronic document creation application for performing the electronic document creating operation of FIG. 3.

Referring to FIG. 3, the control method of the system for creating interactive electronic documents according to the embodiment of the present invention may include: adding a predetermined object on a canvas displayed on the interactive electronic document creation system by a received user input signal (operation S110); forming at least one action slot in one side of the object added on the canvas (operation S120); assigning at least one action attribute and status attribute to the object by a received user input signal (operation S130); forming at least one action slot in one side of the assigned action attribute (operation S140); assigning a predetermined trigger attribute to the action attribute assigned to the object by a received user input signal (operation S150); and storing the object, the action attribute, the status attribute, and the trigger attribute (operation S160).

The control method will be described below in more detail.

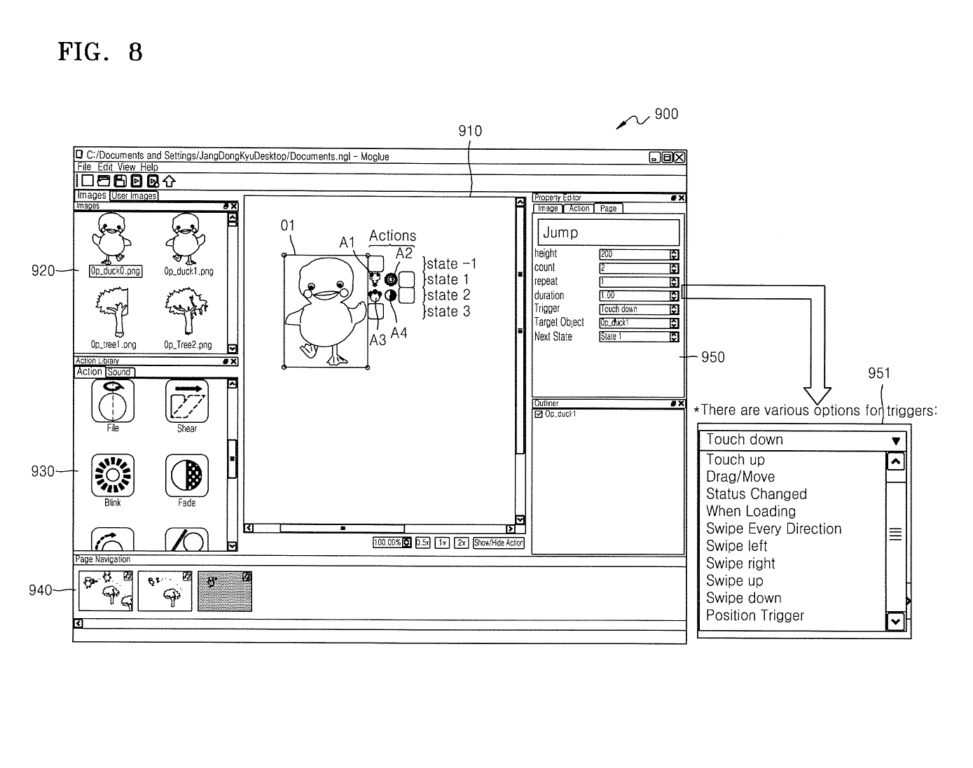

As illustrated in FIG. 4, a user starts creating an electronic document on an empty canvas displayed on an interactive electronic document creation system. A basic screen of an electronic document creation application includes a canvas 910, an object display section 920, an action attribute display section 930, a page list display section 940, and an attribute display section 950. A page being currently edited is displayed on the canvas 910. A plurality of objects capable of being selected by the user are displayed on the object display section 920. A plurality of action attributes capable of selected by the user are displayed on the action attribute display section 930. A preview screen for each generated page is displayed on the page list display section 940. Specified attribute values for the currently selected object or action attribute are displayed on the attribute display section 950. The attribute display section 950 may include a trigger attribute display section (951 in FIG. 8) on which a plurality of trigger attributes capable of being selected by the user are displayed.

In this state, a first object O1 is added on the canvas displayed on the interactive electronic document creation system by a received user input signal (operation S110). In this case, at least one action slot AS is formed in one side of the object added on the canvas (operation S120).

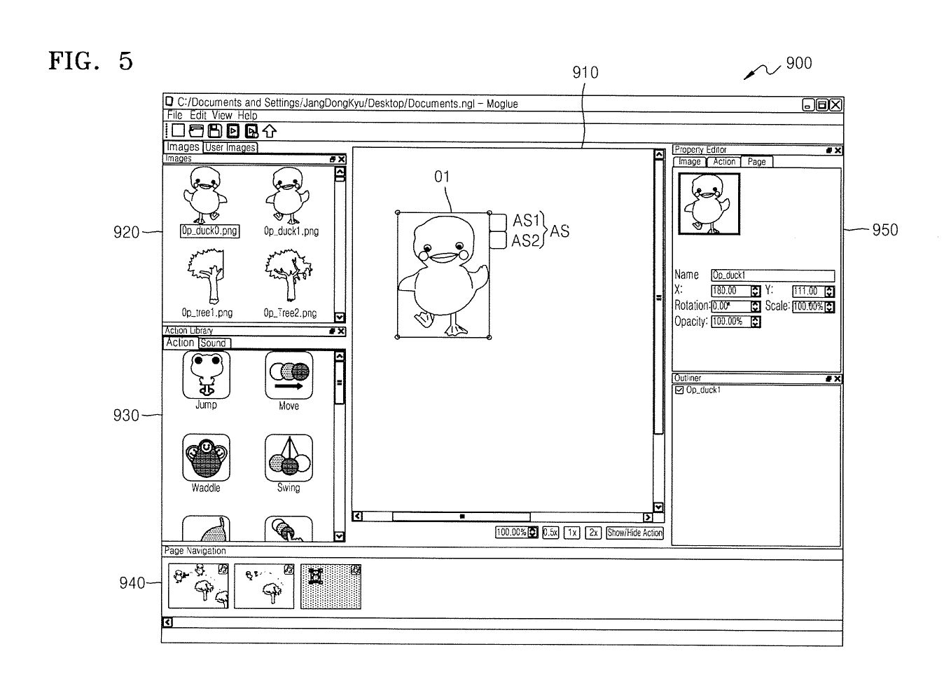

That is, the first object O1 is arranged at a desired position on the canvas 910 in such a manner that the user drags the object displayed on the object display section 920 and drops the object at the desired position on the canvas 910 as illustrated in FIG. 5. This manipulation generates the first object O1 at the desired position on the canvas 910. The arrangement of the object may be achieved by various user input methods, such as a drag and drop signal or a touch and drag signal.

When the first object O1 is generated on the canvas 910, one or more action slots AS1 and AS2 are formed in at least one side of the first object O1 as illustrated in FIG. 5. The action slot AS guides the position and order in which predetermined action attributes are to be added to the corresponding action. With respect to a single object, the action slots may be arranged in a first direction (Y-direction in FIG. 5) and a second direction (X-direction in FIG. 5). The first direction represents the operation execution order, that is, the status attribute, and the action attributes arranged on the same line in the second direction represent the action attributes to be executed in the same status. In other words, since the first action slot AS1 and the second action slot AS2 are arranged in different rows, the action slots AS1 and AS2 have different status attributes. Therefore, the action attribute arranged in the first action slot AS1 and the action attribute arranged in the second action slot AS2 have different status attributes. As a result, the execution orders are also different from each other. It can be understood that the status attribute of the action attribute arranged in the action slot is determined according to the position of each action slot.

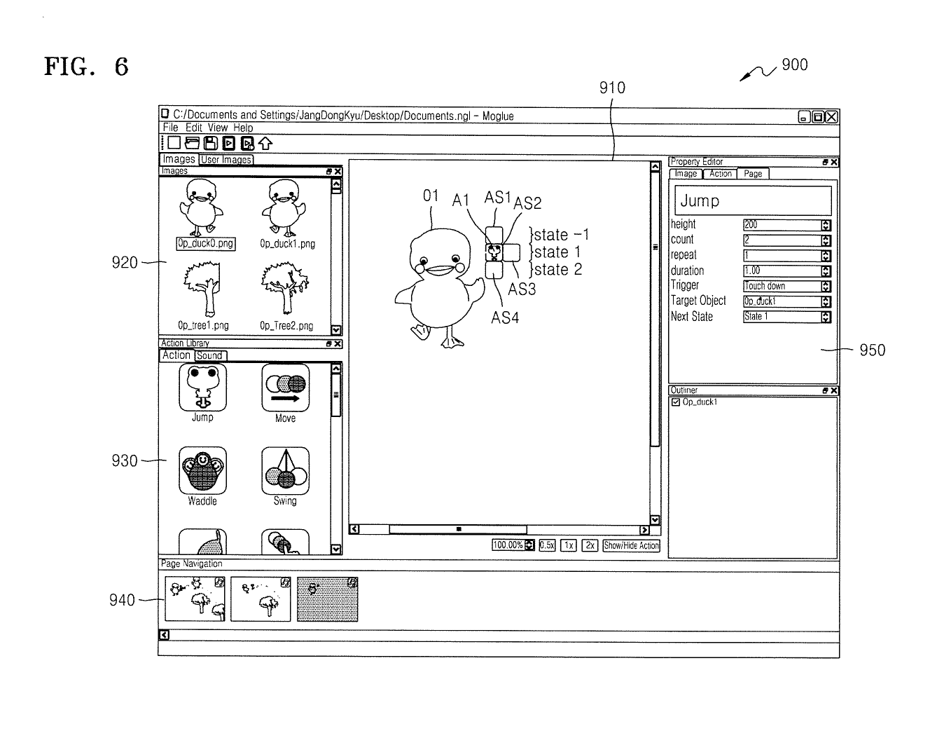

Next, as illustrated in FIG. 6, at least one action attribute and status attribute are assigned to the first object O1 by a received user input signal (operation S130), and at least one action slot is further formed in one side of the assigned action attribute (operation S140).

That is, the action attribute A1 is arranged at a desired action slot AS1 on the canvas 910 in such a manner that the user drags the action attribute displayed on the action attribute display section 930 in the state of FIG. 5 and drops the action attribute at the desired action slot on the canvas 910 as illustrated in FIG. 6. This manipulation generates the action attribute and status attribute to the first object O1. The assignment of the action attribute and status attribute may be achieved by various user input methods, such as a drag and drop signal or a touch and drag signal. When the action attribute is assigned to the first object O1, one or more action slots AS3 and AS4 are further formed in at least one side of the first object O1 as illustrated in FIG. 6.

The arrangement of the action slots illustrated in FIG. 6 is an example of the present invention. By assigning a status attribute of −1 to the action slot AS1 arranged in the first row, the action attributes executed without regard to the status may be arranged. By assigning a status attribute of 1 to the action slots AS2 and AS3 arranged in the second row, the action attributes to be executed for the first time may be arranged. By assigning a status attribute of 2 to the action slot AS4 arranged in the third row, the action attributes to be executed for the second time may be arranged. That is, the status attribute of the action attribute may be automatically determined according to the position of the action slot whose action attribute is dragged and dropped.

Furthermore, when the action attribute is assigned to the first object O1, one or more action slots AS3 and AS4 are further formed in at least one side of the first object O1 as illustrated in FIG. 6. That is, when the first action attribute Al is assigned to the second action slot AS2, the action slots AS3 and AS4 are newly formed on the right and left sides of the second action slot AS2, respectively.

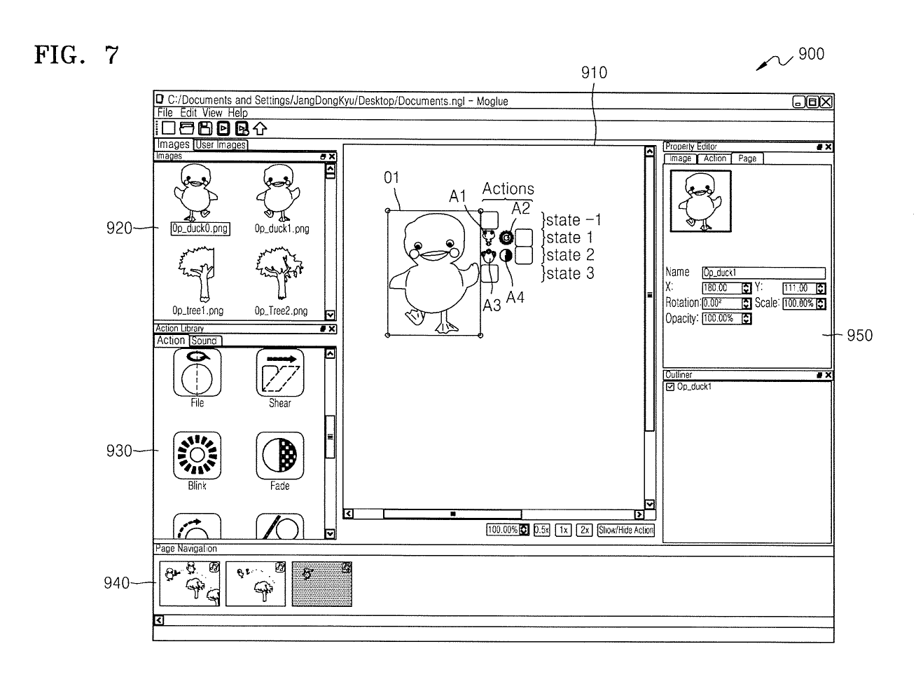

This will be described below in more detail with reference to FIG. 7. Referring to FIG. 7, the four action attributes A1, A2, A3 and A4 are assigned to the first object O1. No action attribute is arranged to the action slot of the first row to which the status attribute of −1 is assigned. The two action attributes, that is, the first action attribute Al and the second action attribute A2, are assigned to the action slot of the second row to which the status attribute of 1 is assigned. In this case, since the action attributes arranged to the same row have the same status attributes, the actions of the first action attribute A1 and the second action attribute A2 have the same action order. (It is apparent that the actual operation time of the first action attribute Al and the second action attribute A2 is determined according to the trigger attribute assigned to each action attribute.)

The two action attributes, that is, the third action attribute A3 and the fourth action attribute A4, are assigned to the action slot of the third row to which the status attribute of 2 is assigned. In this case, since the action attributes arranged to the same row have the same status attributes, the actions of the third action attribute A3 and the fourth action attribute A4 have the same action order. (It is apparent that the actual operation time of the third action attribute A3 and the fourth action attribute A4 is determined according to the trigger attribute assigned to each action attribute.)

Next, a predetermined trigger attribute is assigned to the action attribute assigned to the action by a received user input signal (operation S150).

That is, when a predetermined action attribute is selected in a state of FIG. 7, trigger attributes capable of being selected in the corresponding action attribute are displayed on the trigger attribute display section 951 of the attribute display section 950 in a drop-down form as illustrated in FIG. 8. The trigger attribute for the operation condition of the corresponding action attribute is selected. Examples of the trigger attribute may include a screen touch, a drag/move, a shake, a swipe at a reader, a page loading, and a status attribute change. If such a trigger attribute is assigned to the action attribute, the corresponding action attribute is executed when an action execution condition satisfying the trigger attribute is executed.

The object, the action attribute, the status attribute, and the trigger attribute are stored in the database (150 in FIG. 2) (operation S160).

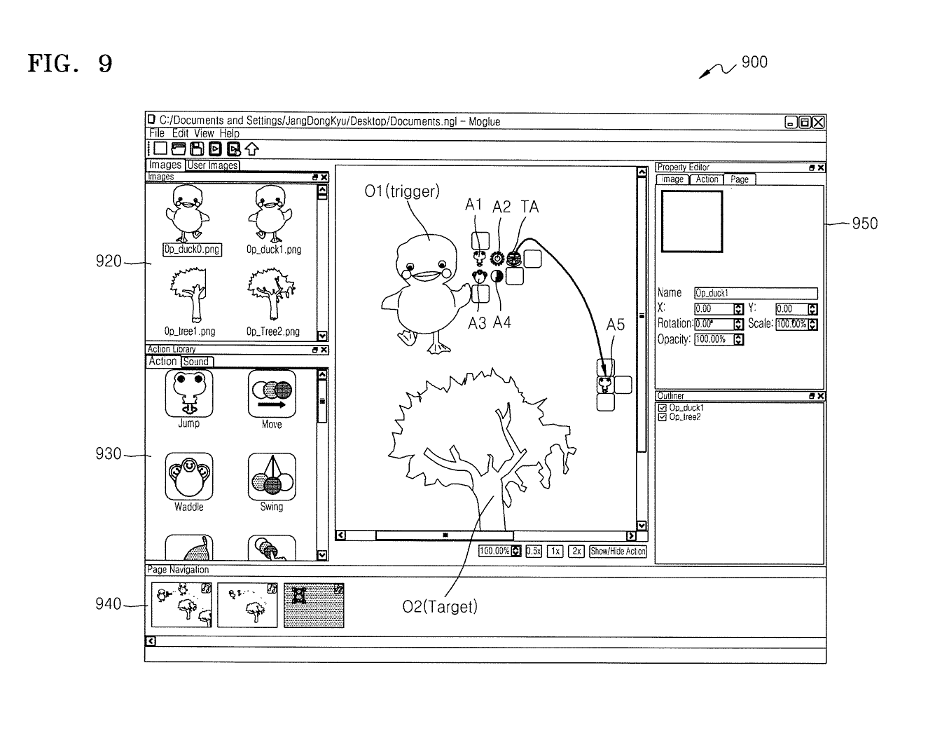

On the other hand, as illustrated in FIG. 9, a plurality of objects O1 and O2 may be arranged on a single page, and separate action attributes may be assigned to each object O1 and O2. That is, the four action attributes, that is, the first, second, third and fourth action attributes A1, A2, A3 and A4, may be assigned to the first object O1, and one action attribute, that is, the fifth action attribute A5, may be assigned to the second object O2.

Moreover, one side of the plurality of objects is set as a target object, and the other side thereof is set as a trigger object. Thus, it may be set to operate the action of the target object when the action of the trigger object is operated,

For example, in FIG. 9, a case where the first object O1 is set as the trigger object and the second object O2 is set as the target object is considered. At this time, when the fifth action attribute AS assigned to the second object O2 is dragged and dropped to the second action attribute A2 assigned to the first object O1, the first object O1 is set as the trigger object and the second object O2 is set as the target object. In this case, when the second action attribute A2 assigned to the first object O1 is operated, the fifth action attribute AS assigned to the second object O2 is operated. That is, when a specific object operates a specific action by connecting a plurality of objects in a cause-and-result relationship, the electronic document may be created such that other object operates a relevant action. Hence, a more diverse story-telling may be obtained.

In other words, when the action condition for the action attribute of the target object is that the status attribute of the trigger object and the status attribute of the target object are a specific status and satisfies the trigger attribute of the trigger object, the action attribute of the target object may be executed. In addition, in this case, the status attribute of the trigger object may be ignored, the status attribute of the target object may be ignored, the attributes of both the trigger object and the target object may be ignored, or the action attribute may be operated even when a predetermined trigger attribute alone is satisfied.

According to the embodiments of the present invention, electronic documents may be created more easily and conveniently.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A control method of a system for creating interactive electronic documents, the control method comprising:
adding one or more objects on a canvas displayed on the system by a received user input signal;
assigning one or more action attributes and status attributes to the object by a received user input signal;
assigning a predetermined trigger attribute to the action attribute assigned to the object by a received user input signal; and
storing at least one of the object, the action attribute, the status attribute, and the trigger attribute.

2. The control method of claim 1, wherein the status attribute is an execution order of the action attribute assigned to each of the objects.

3. The control method of claim 1, wherein a separate trigger attribute is assigned to each of the action attributes.

4. The control method of claim 2, wherein when the object is added on the canvas, one or more action slots are formed in one side of the added object.

5. The control method of claim 4, wherein when the action attribute and the status attribute are assigned to the object by the received user input signal, the action attribute displayed in one side of the canvas is moved to the action slot by a drag and drop signal or a touch and drag signal received by a user interface unit.

6. The control method of claim 4, wherein when the action attribute is assigned to the object, one or more action slots are further formed in one side of the assigned action attribute.

7. The control method of claim 2, wherein the one or more action slots are arranged with respect to one of the objects in a first direction and a second direction different from the first direction, the first direction representing a status attribute that is an action execution order, and the action attributes arranged on a same line in the second direction represent the action attributes to be executed in a same status.

8. The control method of claim 7, wherein when at least a part of the action attributes arranged in the same line in the second direction have a same trigger attribute, the action attributes having the same trigger attribute are simultaneously executed when the trigger is executed.

9. The control method of claim 2, wherein a status attribute to be subsequently executed is set to each of the action attributes.

10. The control method of claim 1, wherein one side of a plurality of objects displayed on the canvas is set as a target object, the other side thereof is set as a trigger object, and the action of the target object is executed when the action of the trigger object is operated.

11. A system for creating interactive electronic documents, the system comprising:
an object control unit that generates, changes, and deletes one or more objects on a canvas displayed on the system by a received user input signal;
an action attribute and status attribute control unit that assigns, changes, and deletes one or more action attributes and status attributes to the object by a received user input signal;
a trigger attribute control unit that assigns, changes, and deletes a predetermined trigger attribute to the action attribute assigned to the object by a received user input signal; and
a control unit that controls the object control unit, the action attribute and status attribute control unit, and the trigger attribute control unit, and stores at least one of the object, the action attribute, the status attribute, and the trigger attribute in a database.

12. The system of claim 11, wherein the status attribute is an execution order of the action attribute assigned to each of the objects.

13. The system of claim 11, wherein a separate trigger attribute is assigned to each of the action attributes.

14. The system of claim 12, wherein when the object is added on the canvas, one or more action slots are formed in one side of the added object.

15. The system of claim 14, wherein the action attribute displayed in one side of the canvas is moved to the action slot by a drag and drop signal or a touch and drag signal received by a user interface unit, and the action attribute and the status attribute are assigned to the object.

16. The system of claim 14, wherein when the action attribute is assigned to the object, one or more action slots are further formed in one side of the assigned action attribute.

17. The system of claim 12, wherein the one or more action slots are arranged with respect to one of the objects in a first direction and a second direction different from the first direction, the first direction representing a status attribute that is an action execution order, and the action attributes arranged on a same line in the second direction represent the action attributes to be executed in a same status.

18. The system of claim 17, wherein when at least a part of the action attributes arranged in the same line in the second direction have a same trigger attribute, the action attributes having the same trigger attribute are simultaneously executed when the trigger is executed.

19. The system of claim 12, wherein a status attribute to be subsequently executed is set to each of the action attributes.

20. The system of claim 11, wherein one side of a plurality of objects displayed on the canvas is set as a target object, the other side thereof is set as a trigger object, and the action of the target object is executed when the action of the trigger object is operated.
